(19) United States
(12) Patent Application Publication
(10) Pub. No.: US 2013/0212623 A1
(43) Pub. Date: Aug. 15, 2013

(54) METHOD AND SYSTEM FOR TRANSMITTING VIDEO OBJECTS

(71) Applicants: Matthias Roebke, Cologne (DE); Martin Hoffmann, Sankt Augustin (DE)

(72) Inventors: Matthias Roebke, Cologne (DE); Martin Hoffmann, Sankt Augustin (DE)

(73) Assignee: DEUTSCHE TELEKOM AG, Bonn (DE)

(21) Appl. No.: 13/812,543

(22) PCT Filed: Jul. 29, 2011
(86) PCT No.: PCT/EP11/03807

§ 371 Date: Mar. 26, 2013

(30) Foreign Application Priority Data
Jul. 30, 2010 (EP) 10007968.0

(51) Int. Cl. H04N 21/81

(52) U.S. Cl. CPC H04N 21/812
USPC 725/34

(57) ABSTRACT

A method for transmitting objects in an Internet Protocol based Television System from a distribution network to a destination terminal of a subscriber via an Internet Protocol transmission line includes: determining a subscriber profile; assigning at least one customized spot to an Internet Protocol Television program; assigning one or more objects to the at least one customized spot, the one or more objects being chosen dependent on the subscriber profile; and providing the Internet Protocol based Television Program and the customized spot to the destination terminal. The one or more objects are provided as realistic objects.

### CROSS-REFERENCE TO RELATED APPLICATIONS

This application is a U.S. National Phase application under 35 U.S.C. §371 of International Application No. PCT/EP2011/003807, filed on Jul. 29, 2011, and claims benefit to European Patent Application No. EP 10007968.0, filed on Jul. 30, 2010. The International Application was published in English on Feb. 2, 2012 as WO 2012/013356 A2 under PCT Article 21(2).

### FIELD

The present invention relates to a method for transmitting objects in an Internet Protocol based Television System from a distribution network to a destination terminal of a subscriber via an Internet Protocol transmission line. Furthermore, the present invention relates to a system for providing the transmission of objects in an Internet Protocol Television System from a distribution network to a destination terminal of a subscriber via an Internet Protocol transmission line.

### BACKGROUND

Television as an advertising medium has undergone significant advances since its inception in 1939. Modern advances in digital technology now allow viewers to be very selective in choosing programs to watch. Other advances in digital technology have led to such programming enhancements as a “tail” on a hockey puck, or an overlaid first down marker on a football field. The same technological advances allow improvements in the way advertisements are currently presented. Many sporting events are now presented with virtual object advertisements included in the video. For example, the broadcast of a major league baseball game may include one or more virtual object spots in which an advertisement is displayed. The advertisements are then seen by television viewers, but not by fans who attend the game. However, the advertisements are fixed, and are not varied according to individual viewers. Furthermore, the advertisements presently have the following characteristics:
the advertisement does not necessarily have something to do with the content of the television program;
the advertisement is broadcast to all receivers of the program or (in case there is a geographical differentiation) at least to a huge number of receivers;
the advertisement is not at all personalized for a specific receiver or a specific subscriber of the television program.

These and other characteristics of present day television programs and associated advertisement spots have the drawback that no personalized or customized advertisement is possible today.

### SUMMARY

In an embodiment, the present invention provides a method for transmitting objects in an Internet Protocol based Television System from a distribution network to a destination terminal of a subscriber via an Internet Protocol transmission line. The method includes: determining a subscriber profile; assigning at least one customized spot to an Internet Protocol Television program; assigning one or more objects to the at least one customized spot, the one or more objects being chosen dependent on the subscriber profile; and providing the Internet Protocol based Television Program and the customized spot to the destination terminal The one or more objects are provided as realistic objects.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows schematically an overview of an inventive system for providing the transmission of objects in an Internet Protocol based Television from a distribution network to a destination terminal

FIG. 2 shows schematically a program with a customized spot delivered or transmitted to the destination terminal

### DETAILED DESCRIPTION

In an embodiment, the present invention provides a method for transmitting objects in an Internet Protocol based Television System such that a personalized or customized emission of content and associated objects, preferably advertisement objects, is possible in a convenient, easy and cost efficient manner.

An embodiment of the present invention provides a method for transmitting objects in an Internet Protocol based Television System from a distribution network to a destination terminal of a subscriber via an Internet Protocol transmission line, the method comprising:
determining a subscriber profile,
assigning at least one customized spot to an Internet Protocol based Television program;
assigning one or more objects to the at least one customized spot, the one or more objects being chosen dependent on the subscriber profile;
providing the Internet Protocol Television program and the customized spot to the destination terminal,
   wherein the one or more objects are provided as realistic, embedded objects, especially video objects.

Thereby, it is advantageously possible to enhance the quality of the objects and hence the quality of the Internet Protocol based Television program transmitted to the destination terminal and to the subscriber.

According to the present invention, it is preferred that the realistic objects are recorded images of real world objects, the images especially being recorded by means of a camera.

In another embodiment, the present invention provides a method for transmitting objects in an Internet Protocol based Television System from a distribution network to a destination terminal of a subscriber via an Internet Protocol transmission line, the method comprising:
determining a subscriber profile,
assigning at least one customized spot to an Internet Protocol Television program;
assigning one or more objects to the at least one customized spot, the one or more objects being chosen dependent on the subscriber profile;
providing the Internet Protocol based Television program and the customized spot to the destination terminal,
   wherein the determination of the subscriber profile is conducted using data, linked by a service provided to the subscriber, wherein the service is different from the Internet Protocol based Television service.

Thereby, it is advantageously possible according to the present invention to adapt or modify the subscriber profile based on other data than those transmitted via the Internet Protocol based Television Service interface, e.g. it is possible to use the data obtained during web surfing of the subscriber in order to determine the subscriber profile.

According to the present invention, the content information of the Internet Protocol based Television Program (also called a primary content to be transmitted by the Internet Protocol based Television Service) is enhanced by the customized spot assigned to that program. The customized spot is in most cases used to enhance the program (or primary content) by, e.g., advertisement information. Classically, such advertisement information was simply assigned to the program by interrupting the program but this simple proceeding is no longer appreciated by customers or subscribers. Therefore, more intelligent realizations of joining an Internet Protocol based Television Program content with the content of a customized spot are suggested in this invention. For example, a customized spot can be assigned to the Internet Protocol based Television program by means of defining parts of the Internet Protocol Television based program which are replaced (or overlaid) by the customized spot, where the parts to be replaced or overlaid do not necessarily form a sequence for full frame images of the Internet Protocol based Television program. According to the present invention, parts of the video and/or audio material of the Internet Protocol based Television Program are replaced or overlaid by means of video and/or audio material of the customized spot, and, as the customized spot itself comprises at least one object (but preferably a plurality of objects), at least a part (but preferably a plurality of parts) of the Internet Protocol based Television Program is/are also replaced by the object or the plurality of objects. Thereby, it is advantageously possible to integrate advertisement contents in a more intelligent manner in the Internet Protocol based Television Program. For example, it is possible to use features described in the MPEG 4 standard for replacing content of the original Internet Protocol based Television Program content by content of the customized spot and the objects (or object) assigned to the customized spot. At least some of the features of the MPEG 4 standard are described in document ISO/IEC JTC1/SC29/WG11 N4668, March 2002, which is incorporated by reference in its entirety in the present patent application. According to the present invention, it is possible, that e.g. a replacement of the following type is provided by means of the customized spot comprising one or more objects assigned to an Internet Protocol based Television Program: In a film sequence, an actor holds a can of a drink of a first brand. According to the present invention, it is possible that it is a can of another brand of a drink what the customer or subscriber actually sees when the Internet Protocol based Television Program is delivered to the destination terminal with the customized spot. By means of using the customized spot, it is advantageously possible according to the present invention that parts of the Internet Protocol based Television program are designated for replacement by the content of the customized spot and/or the objects (or object) assigned to the customized spot.

In the context of the present invention, the term “spot” or “customized spot” refers to an entity to which at least one object (i.e. 1 to n objects, n being an integer) is assigned. It is preferred according to the present invention that such a spot or customized spot furthermore comprises, for each one of the assigned objects, one defined identifier. The defined identifier is preferably unambiguously assigned to the related object, i.e. there is, within the structure of the customized spot, a one-to-one relationship between the identifiers on the one hand and the objects on the other hand. It is furthermore preferred according to the present invention that further pieces of information can be attributed to an identifier (or to an object of the spot). Such further pieces of information comprise, e.g.:
an indication in which one or in which ones of the frames (of the Internet Protocol based Television Program content) the object occurs,
an indication as to the perspective, orientation or viewing direction and/or distortion of the object,
an indication relating to the brightness and/or contrast of the object.

According to the present invention, it is furthermore preferred that the determination of the subscriber profile is conducted using data transported on the Internet Protocol transmission line between the destination terminal and the distribution network.

Thereby, it is advantageously possible to use data obtained from online activities of the subscriber for establishing the subscriber profile. According to a preferred embodiment of the present invention, the service provider providing the Internet Protocol based Television Service is either identical with the service provider providing another online service transmitted on the Internet Protocol transmission line between the destination terminal and the distribution network, or the service provider providing the Internet Protocol Television service is at least linked to the service provider providing another online service transmitted on the Internet Protocol transmission line between the destination terminal and the distribution network. Thereby, it is advantageously possible to use the data obtained for the determination of the subscriber profile.

According to the present invention, it is also preferred that the Internet Protocol based Television Service is provided using a multicast transmission from a head end to a multicast point, and a unicast transmission from the multicast point to the destination terminal

Thereby, it is advantageously possible to realize an efficient transport of the Internet Protocol based Television Content data from the Internet Protocol Television head end to the destination terminal and nevertheless provide a personalized or customized delivery of Internet Protocol based Television Content.

Furthermore, it is preferred according to the present invention, that a feedback information is transmitted to the distribution network such that the assignment of the objects to the at least one customized spot is performed dependent on the feedback information.

Thereby, it is advantageously possible for the subscriber or user of the Internet Protocol based Television Service to choose—at least partly—the objects assigned to the at least one customized spot. For example, it is possible for the subscriber to choose the products advertised within the objects. For example, it is possible according to this embodiment of the present invention that the subscriber is able to prevent the replacement of parts of the content of the Internet Protocol based Television Program (or prevent the replacement of parts of the primary content) in case he or she chooses so.

According to another preferred embodiment of the present invention, the destination terminal belongs to a group of a plurality of destination terminals such that the group of destination terminals receives identical or at least similar objects within a predetermined interval of time. According to an alternative embodiment, it is also preferred according to the present invention that the destination terminal belongs to a group of a plurality of destination terminals such that the group of destination terminals receives, together with a specific Internet Protocol based Television Program, at least one customized spot being identical or at least similar within the group of the plurality of destination terminals and within a predetermined interval of time.

Thereby, it is advantageously possible to reduce the complexity in the distribution of objects related to at least one customized spot emitted together with an Internet Protocol based Television Program.

According to all embodiments of the present invention, the objects to be assigned to the at least one customized spot are preferably video objects. Alternatively or cumulatively, the objects to be assigned to the at least one customized spot can also be audio objects or audio-visual objects. According to another embodiment of the present invention, the objects to be assigned to the at least one customized spot can also be sensorical objects, e.g. relating to the olfaction or the sense of smell. According to another embodiment of the present invention, the objects to be assigned to the at least one customized spot can also be haptic or relate to the sense of touch.

The present invention also relates to a system for providing the transmission of objects in an Internet Protocol based Television System from a distribution network to a destination terminal of a subscriber via an Internet Protocol transmission line, wherein the determination of a subscriber profile is provided, wherein the assignment of at least one customized spot to an Internet Protocol based Television Program is provided, wherein the assignment of one or more objects to the at least one customized spot is provided, the one or more objects being chosen dependent on the subscriber profile, and wherein a transmission of the Internet Protocol based Television Program and of the customized spot to the destination terminal is provided, the one or more objects being provided as realistic objects.

Furthermore, the present invention relates to a program comprising a computer readable program code for executing an inventive method or for configuring or controlling an inventive system.

The destination terminal may be incorporated into the circuitry of a television, thereby eliminating the need for a separate control device attached to the television. Alternatively, the reception site may be incorporated into a personal computer, personal data device, smart phone with a display, or electronic book device

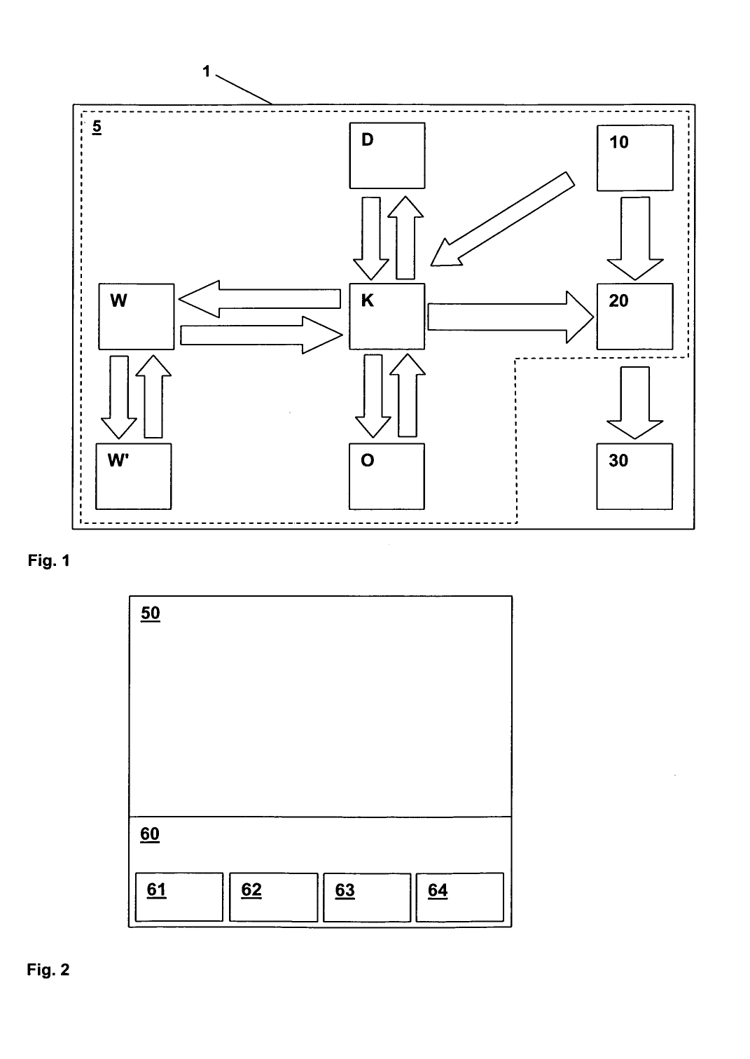

An overview of the system for providing the transmission of objects in an Internet Protocol based Television System from a distribution network 5 to a destination terminal 30 is depicted in FIG. 1. As a part of the distribution network 5, an Internet Protocol based Television head end 10 is a source of primary content data, i.e. Internet Protocol based Television Programs. In a distribution only embodiment of an Internet Protocol based Television System, such primary content or Internet Protocol Television based Program is transmitted to a destination terminal 30 either in unmodified form or at least not in a customized manner, i.e. customized either individually for a subscriber or group-customized for a specifically defined group of subscribers. In the embodiment shown in FIG. 1, the distribution network 5 also comprises a multicast point 20 which is provided on the transmission line between the head end 10 and the destination terminal 30. The multicast point 20 serves as an intermediate distribution point for facilitating the distribution of the Internet Protocol based Television Program to the subscriber (i.e. to the destination terminal 30).

According to the present invention, the Internet Protocol based Television Program content is not delivered unmodified to the destination terminal or at least it is possible according to the present invention that the Internet Protocol based Television Program content is modified. According to the present invention, this modification is provided by means of a customized spot assigned to the Internet Protocol Television program, i.e. assigned to the primary content. By means of using the customized spot, it is advantageously possible according to the present invention that parts of the Internet Protocol based Television program are designated for replacement by the content of the customized spot and/or the objects (or object) assigned to the customized spot. The customized spot comprises one or a plurality of objects. In FIG. 2, this is schematically represented: to the primary content, i.e. to the Internet Protocol based Television Program 50, is assigned or associated a customized spot 60. The customized spot 60 comprises one or a plurality of objects, in the case depicted in FIG. 2, these comprise a first object 61, a second object 62, a third object 63, and a fourth object 64.

The modification of the Internet Protocol based Television Program content (which corresponds to the primary content) is done by means of further network components of the distribution network 5. In the example represented in FIG. 1, these further network components comprise:
a database network entity D comprising user data or a subscriber profile for specific subscribers or customers of the Internet Protocol based Television Service (or subscriber profile data for specific groups of subscribers);
an object and/or spot to movie matrix entity O comprising, for assigning, a specific customized spot (or specific customized spots) and/or a specific object 61, 62, 63, 64 or a specific group of objects 61, 62, 63, 64 (to be assigned to the customized spots or the customized spot) to a specific Internet Protocol Television program, e.g. a movie;
an advertisement entity W comprising a pool of different objects 61, 62, 63, 64 available for being put into the Internet Protocol based Television Program content delivered to the destination terminal in exchange for original Internet Protocol based Television Program content;
a further advertisement entity W′ comprising a pool of different objects 61, 62, 63, 64 that have not yet been used
a control entity K controlling the distribution of objects to the different Internet Protocol based Television programs and the transmission to the multicast point 20.

In the following the method according to the present invention is schematically described with respect to an example: The control entity K is connected with the database network entity D, the object to movie matrix entity O, the advertisement entity W, and with the Internet Protocol based Television head end 10. It is supposed that a subscriber profile is determined for a specific subscriber or group of subscribers and stored in the database network entity D. From the Internet Protocol based Television head end 10, an information regarding the specific subscriber or group of subscribers is received by the control entity K, indicating that a specific Internet Protocol based Television Program, e.g. a movie, is requested by that subscriber or group of subscribers. According to the present invention, the control entity K delivers an information stream or content stream to the multicast point 20 in order for a delivery or transmission to the destination terminal, i.e. the subscriber (or group of subscribers). Prior to delivering the information stream or content stream to the multicast point 20, a customized spot 60 is to be assigned to the Internet Protocol Television program and one or more objects 61, 62, 63, 64 need to assigned to the customized spot 60 (dependent on the subscriber profile).

These two steps of assigning at least one customized spot 60 to the Internet Protocol based Television Program 50 and of assigning one or more objects 61, 62, 63, 64 to the customized spot are described in the following:
using the information regarding the subscriber (or group of subscribers) (received from the Internet Protocol based Television head end 10), the control entity K retrieves the subscriber profile from the database network entity D;
dependent on the pool of different objects 61, 62, 63, 64 available at the advertisement entity W and the further advertisement entity W′ for being put into the Internet Protocol Television based Program content, the customized spot to assign to the requested Internet Protocol based Television Program is determined by the control entity K;
by means of the object to movie matrix entity O, the objects 61, 62, 63, 64 to be assigned to the customized spot are specifically chosen and assigned to the spot 60 so that the overall media content to be delivered to the destination terminal 30, i.e. including not only the Internet Protocol Television program 50 but also the customized spot 60 (comprising the objects 61, 62, 63, 64), is ready for delivery by the multicast point 20.

According to the present invention, it is preferred, that the subscriber profile comprises an indication or information regarding the preference of the subscriber related to some brands or advertisement elements with regard to other advertisement elements. Advantageously, these preferences or this preference information can be considered during the process of assigning the customized spot 60 to the Internet based Protocol Television Program 50 as well as during the process of assigning the objects 61, 62, 63, 64 to the customized spot 60.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise.

1-11. (canceled)

12. A method for transmitting objects in an Internet Protocol based Television System from a distribution network to a destination terminal of a subscriber via an Internet Protocol transmission line, the method comprising:
determining a subscriber profile;
assigning at least one customized spot to an Internet Protocol Television program;
assigning one or more objects to the at least one customized spot, the one or more objects being chosen dependent on the subscriber profile; and
providing the Internet Protocol based Television Program and the customized spot to the destination terminal;
wherein the one or more objects are provided as realistic objects.

13. The method according to claim 12, wherein the realistic objects are recorded images of real world objects.

14. The method according to claim 12, wherein the Internet Protocol based Television Service is provided using a multicast transmission from a head end to a multicast point, and a unicast transmission from the multicast point to the destination terminal.

15. The method according to claim 12, wherein a feedback information is transmitted to the distribution network such that the assignment of the objects to the at least one customized spot is performed dependent on the feedback information.

16. The method according to claim 12, wherein the destination terminal belongs to a group of a plurality of destination terminals, and wherein the group of destination terminals receives similar objects within a predetermined interval of time

17. The method according to claim 12, wherein the destination terminal belongs to a group of a plurality of destination terminals, wherein the group of destination terminals receives, together with a specific Internet Protocol based Television Program, at least one customized spot being similar within the group of the plurality of destination terminals and within a predetermined interval of time.

18. The method according to claim 12, wherein the objects are at least one of video objects, audio objects, audio-visual objects, or sensorial objects.

19. A method for transmitting objects in an Internet Protocol based Television System from a distribution network to a destination terminal of a subscriber via an Internet Protocol transmission line, the method comprising:
determining a subscriber profile;
assigning at least one customized spot to an Internet Protocol Television program;
assigning one or more objects to the at least one customized spot, the one or more objects being chosen dependent on the subscriber profile; and
providing the Internet based Protocol Television Program and the customized spa the destination terminal;
wherein the determination of the subscriber profile is conducted using data linked by a service provided to the subscriber, wherein the service is different from the Internet Protocol based Television Service.

20. The method according to claim 19, wherein the determination of the subscriber profile is conducted using data transported on the Internet Protocol transmission line between the destination terminal and the distribution network.

21. The method according to claim 19, wherein the Internet Protocol based Television Service is provided using a multicast transmission from a head end to a multicast point, and a unicast transmission from the multicast point to the destination terminal.

22. The method according to claim 19, wherein a feedback information is transmitted to the distribution, network such that the assignment of the objects to the at least one customized spot is performed dependent on the feedback information.

23. The method according to claim 19, wherein the destination terminal belongs to a group of a plurality of destination terminals, and wherein the group of destination terminals receives similar objects within a predetermined interval of time.

24. The method according to claim 19, wherein the destination terminal belongs to a group of a plurality of destination terminals, wherein the group of destination terminals receives, together with a specific Internet Protocol based Television Program, at least one customized spot being similar within the group of the plurality of destination terminals and within a predetermined interval of time.

25. The method according to claim 19, wherein the objects are at least one of video objects, audio objects, audio-visual objects, or sensorial objects.

26. A system for providing the transmission of objects in an Internet Protocol based Television System from a distribution network to a destination terminal of a subscriber via an Internet Protocol transmission line, the system comprising:
a database network entity comprising subscriber profiles;
a matrix entity, configured to assign spots or objects to specific Internet Protocol Television programs;
at least one advertisement entity comprising objects to be put into Internet Protocol based Television programs; and
a control entity for controlling the distribution of objects to different Internet Protocol based Television programs and the transmission to the multicast point;
wherein the system is configured to determine a subscriber profile, assign at least one customized spot to an Internet Protocol based Television Program, assign one or more objects to the at least one customized spot, the one or more objects being chosen dependent on the subscriber profile, and transmit the Internet Protocol based Television Program and the customized spot to the destination terminal; and
wherein the one or more objects are provided as realistic objects.

27. A non-transitory computer-readable medium having computer-executable instructions stored thereon for transmitting objects in an Internet Protocol based Television System from a distribution network to a destination terminal of a subscriber via an Internet Protocol transmission line, the computer-executable instructions, when executed by a processor, causing the following steps to be performed:
determining a subscriber profile;
assigning at least one customized spot to an Internet Protocol Television program;
assigning one or more objects to the at least one customized spot, the one or more objects being chosen dependent on the subscriber profile; and
providing the Internet Protocol based Television Program and the customized spot to the destination terminal;
wherein the one or more objects are provided as realistic objects.
